(19) United States
(12) Patent Application Publication
(10) Pub. No.: US 2002/0006571 A1
(43) Pub. Date: Jan. 17, 2002

(54) Liquid toner composition and method of manufacturing the same

(76) Inventors: Yasuharu Suda, Hiroshima (JP); Hiroaki Kuno, Hiroshima (JP)

Correspondence Address: John P White, Cooper & Dunham LLp, 1185 Avenue of the Americas, New York, NY, 10036, US

(21) Appl. No.: 09/526,602

(22) Filed: Mar. 16, 2000

(51) Int. Cl. G03G 9/12

(52) U.S. Cl. 430/114; 430/115; 430/137.22

(57) ABSTRACT

Disclosed is a liquid toner composition prepared by dispersing toner particles consisting essentially of a colorant and a resin in a carrier liquid, the resultant composition forming an electrorheological fluid.

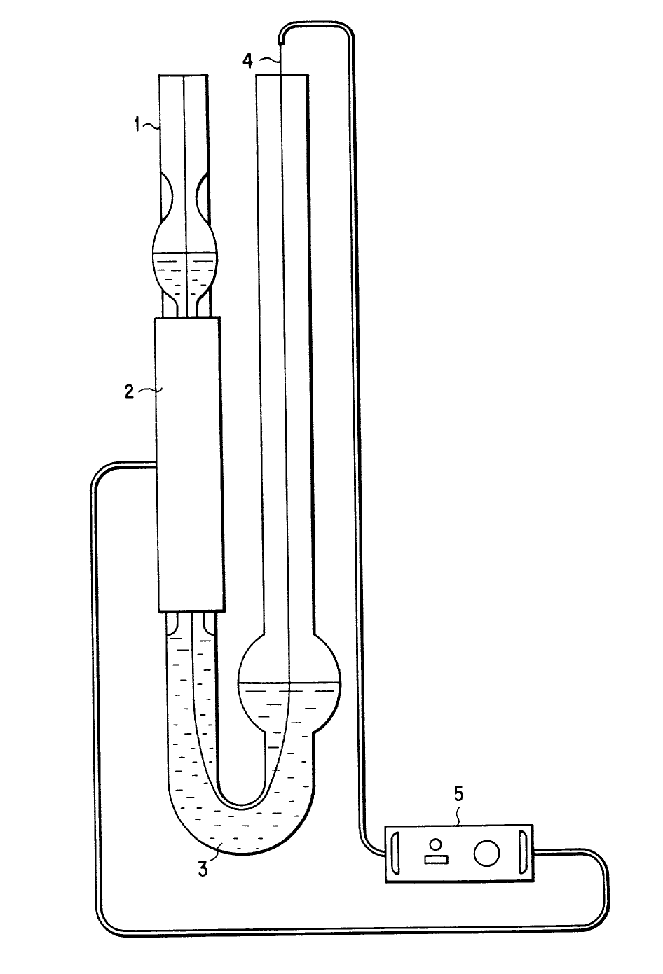

### BACKGROUND OF THE INVENTION

The present invention relates to a liquid toner composition and a method of manufacturing the same.

The conventional liquid toner composition for electrophotography comprises, for example, an electrically insulating carrier liquid, coloring particles dispersed in the carrier liquid, a resin soluble in an electrically insulating liquid and serving to disperse and fix the coloring particles, and a charge controller for charging the coloring materials positive or negative. The coloring particles contained in the composition are excellent in dispersion capability to make the toner composition excellent in resolution. However, the conventional liquid toner composition is poor in its fixing capability. Also, the agglomerating force of the coloring particles is low in the image portion. It follows that, when a picture image is transferred from a photosensitive body to a supporting sheet, the image is likely to be collapsed so as to bring about flow of the toner particles, leading to deterioration of the transferred picture image.

As a measure for overcoming the above-noted difficulty, proposed is a liquid toner composition prepared by dispersing toner particles consisting of a pigment and a resin in an electrically insulating liquid, said resin being substantially insoluble in said electrically insulating liquid. Also proposed in, for example, Japanese Patent Publication (Kokoku) No. 5-87825, is a technical idea that the toner particles are shaped to have fiber-like projections so as to increase the agglomerating force among the toner particles.

However, if the agglomerating force among the toner particles dispersed in a liquid is unduly high, the toner particles tend to be excessively agglomerated to form large coarse particles which are likely to be precipitated. Further, in the step of developing the electrostatic latent image formed on the surface of a photosensitive body, the presence of the agglomerated toner particles brings about reduction of resolution.

### BRIEF SUMMARY OF THE INVENTION

An object of the present invention is to provide a liquid toner composition containing toner particles which do not exhibit a high agglomerating force and are excellent in dispersion capability during storage and development of the composition, and which exhibit an increased agglomerating force in the transferring step so as to suppress collapsing and flow of the picture image, leading to an improved picture image. The present invention is also intended to provide a method of manufacturing the particular liquid toner composition.

According to a first aspect of the present invention, there is provided a liquid toner composition prepared by dispersing toner particles consisting essentially of a colorant and a resin in a carrier liquid, the resultant composition forming an electrorheological fluid.

The property of forming an electrorheological fluid is herein called ER (Electro Rheological) property.

According to a second aspect of the present invention, there is provided a method of manufacturing a liquid toner composition, comprising the step of heating, dissolving, mixing and dispersing a thermoplastic resin in a solvent having a high temperature dependency in its capability of dissolving the thermoplastic resin and having its solubility parameter adjusted for controlling the size of toner particles, followed by cooling to permit the toner particles to be precipitated, wherein inorganic fine particles are added by at latest the stage immediately before initiation of the toner particle precipitation.

Additional object and advantages of the invention will be set forth in the description which follows, and in part will be obvious from the description, or may be learned by practice of the invention. The object and advantages of the invention may be realized and obtained by means of the instrumentalities and combinations particularly pointed out in the appended claims.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIGURE shows how to evaluate the ER property of the liquid toner composition of the present invention.

### DETAILED DESCRIPTION OF THE INVENTION

The present invention provides a liquid toner composition prepared by dispersing toner particles consisting essentially of a colorant and a resin in a liquid carrier. It is desirable for inorganic fine particles to be attached to or impregnated in at least the surface region of the toner particle. The inorganic fine particles used in the present invention are formed of, for example, silica, silica which is made hydrophobic, titanium oxide or titanium hydroxide.

A pigment used in general for preparing an ink composition, a toner composition, etc. can be used in the present invention as the colorant contained in the liquid toner composition. For example, a black pigment used in the present invention includes various carbon blacks including all the carbon blacks prepared by, for example, a furnace method, a contact method and an acetylene method and available on the market for use in the manufacture of rubber and a coloring material and for use as an electrically conductive material. To be more specific, classification of carbon black is given on pages 290 to 291 of “Carbon Black Binran (Manual)” published in April, 1995. The carbon black used in the present invention includes any classification of HCF, MCF, RCF, LCF, LFF, which are prepared by a furnace method, and HCC, MCC, RCC, LCC, which are prepared by a channel method. Further, various acetylene blacks given on page 294 of “Carbon Black Binran” noted above can also be used in the present invention.

The non-black pigment used in the present invention as the colorant includes, for example, phthalocyanine blue, phthalocyanine green, sky blue, rhodamine lake, malachite green lake, Hansa yellow, benzidine yellow, and brilliant carmine 6B.

The pigment can be used in combination with a dye such as an oil soluble azo dye including oil black and oil red, a basic azo dye including bismark brown, an acidic azo dye including blue black HF, and quinone imine dye including nigrosine. Further, it is possible to use a so-called “processed pigment”, i.e., a pigment having the surface coated with a resin.

The colorant is added in advance to a thermo-plastic resin by means of kneading under heat. Alternatively, the colorant can be added during manufacture of the liquid toner composition of the present invention. Specifically, the colorant can be added before precipitation of the toner particles.

The resin used in the present invention should desirably a thermoplastic resin including, for example, vinyl chloride resin, vinylidene chloride resin, vinyl acetate resin, polyvinyl acetal resin, styrene series resin, methacrylic acid series resin, polyethylene resin, polypropylene resin, fluorine-containing resin, polyamide series resin, polyacetal resin, and saturated polyester resin. It is particularly desirable to use olefin resins having carboxyl groups or ester bonds including, for example, ethylene-vinyl acetate copolymer, partially saponified ethylene-vinyl acetate copolymer, ethylene-acrylic acid copolymer, ethylene-methacrylic acid copolymer, ethylene-acrylic acid ester copolymer, ethylene-methacrylic acid ester copolymer, acrylic acid ester resin, methacrylic acid ester resin, styrene-acrylic acid copolymer, styrene-methacrylic acid copolymer, styrene-acrylic acid ester copolymer, and styrene-methacrylic acid ester copolymer. These resins can be used singly or in the form of a mixture of at least two kinds of resins. Also, these resins can be mixed in an amount of 50 to 99% by weight relative to 50 to 1% by weight of the pigment.

The carrier liquid used in the present invention includes, for example, a linear or branched aliphatic hydrocarbon, alicyclic hydrocarbon and halogenated derivatives thereof. It is also possible to use silicone oils. Specific examples of the carrier liquid used in the present invention include, for example, Isopar G (trade name of a carrier liquid produced by Exxon Inc.), Isopar H (trade name of a carrier liquid produced by Exxon Inc.), Isopar K (trade name of a carrier liquid produced by Exxon Inc.), Isopar L (trade name of a carrier liquid produced by Exxon Inc.), Isopar M (trade name of a carrier liquid produced by Exxon Inc.), Isopar V (trade name of a carrier liquid produced by Exxon Inc.), Shellzole 71 (trade name of a carrier liquid produced by Shell Oil Co., Ltd.), IP1620 (trade name of a carrier liquid produced by Idemitsu Petrochemical Co., Ltd.), IP2028 (trade name of a carrier liquid produced by Idemitsu Petrochemical Co., Ltd.), IP2835 (trade name of a carrier liquid produced by Idemitsu Petrochemical Co., Ltd.), cylooctane, cyclodecane, and TSF451 series (trade name of silicone oils produced by Toshiba Silicone Inc.).

The solvent used in the present invention for dissolving the resin should be capable of dissolving the resin in the heating step and should be substantially incapable of dissolving the resin at room temperature. In the present invention, the solvent is used for controlling the diameter of the precipitated toner particles. Therefore, the SP (Solubility Parameter) value of the solvent is specified in the present invention. It should be noted that a differential SP value (ASP) between the SP value of the resin itself and that of the solvent should be as small as possible for diminishing the toner particle diameter. The solvent meeting the particular requirements includes, for example, linear or branched aliphatic hydrocarbons, halogenated aliphatic hydrocarbons, aromatic hydrocarbons, aliphatic alcohols and ethers. These solvents can be used singly or in the form of a mixture.

The inorganic fine particles used in the present invention include, for example, silica-based particles such as silica particles and silica gel particles and titanium-based particles such as titanium oxide particles and titanium hydroxide particles. The particle diameter and the specific surface area of the inorganic fine particles, which can be chosen as desired, should desirably fall within a range of between 2 nm and 500 nm in terms of the primary particle diameter and within a range of between 20 m²/g and 500 m²/g, respectively.

In order to control the dispersion capability or affinity with the resin of the inorganic fine particles, it is also possible to use inorganic fine particles having the surface treated with an organic material or hydroxide. Specific surface-treated silica-based inorganic fine particles used in the present invention include, for example, Aerozyl series particles produced by Japan Aerozyl Co., Ltd. such as Aerozyl 130, Aerozyl 200, Aerozyl 200 SV, Aerozyl 200 CF, Aerozyl 300, Aerozyl 300 CF, Aerozyl 380, Aerozyl R972, Aerozyl R974, Aerozyl R202, Aerozyl R805, Aerozyl R812, Aerozyl OX50, Aerozyl TT600, Aerozyl MOX80, Aerozyl MOX170, Aerozyl COK84, OSCAL-135 manufactured by Shokubai-Kasei Kogyo K.K., pulverized silica gels of CARIACT series manufactured by Fuji Silicia Chemical Inc., i.e., CARIACT-15, CARIACT-30 and CARIACT-50. On the other hand, specific surface-treated titanium-based inorganic fine particles used in the present invention include, for example, STR series particles produced by Sakai Kagaku Kogyo K.K. such as STR-40, STR-60, STR-65, STR-80, STR-100, and C-11 produced by Ishihara Sangyo Kaisha Ltd.

Further, an antistat and/or a dispersant can be added to the liquid toner composition of the present invention. The antistat used in the conventional developing agent can be used in the present invention. For example, the antistat used in the present invention include nigrosine series dyes; metal soaps such as manganese naphthenate, calcium naphthenate, zirconium naphthenate, cobalt naphthenate, iron naphthenate, lead naphthenate, nickel naphthenate, chromium naphthenate, zinc naphthenate, magnesium naphthenate, manganese octylate, calcium octylate, zirconium octylate, iron octylate, lead octylate, cobalt octylate, chromium octylate, zinc octylate, magnesium octylate, manganese dodecylate, calcium dodecylate, zirconium dodecylate, iron dodecylate, lead dodecylate, cobalt dodecylate, nickel dodecylate, chromium dodecylate, zinc dodecylate and magnesium dodecylate; alkylbenzene sulphonates such as calcium dodecylbenzene sulphonate, sodium dodecylbenzene sulphonate, barium dodecylbenzene sulphonate; phospholipids such as lecithin and cephalin; and organic amines such as n-decyl amine. These antistats can be used singly or in combination.

It suffices to use the antistat in an amount sufficient for obtaining an antistat effect. In general, the amount of the antistat should be 0.5 to 50% by weight, preferably 1 to 30% by weight, based on the amount of the solid components of the liquid toner composition.

The dispersant used in the present invention should desirably be an anionic or nonionic surfactant having ethylene oxide added thereto as a hydrophilic group. When it comes to the anionic surfactant, it is desirable to use a phosphate ester of a higher alcohol ethylene oxide adduct, which is classified as a phosphate ester. On the other hand, the nonionic surfactant used in the present invention includes, for example, a higher alcohol ethylene oxide adduct, alkylphenol fatty acid ester ethylene oxide adduct, fatty acid ethylene oxide adduct, polyhydric alcohol fatty acid ester ethylene oxide adduct, higher alkylamine ethylene oxide adduct, fatty acid amide oxide adduct, ethylene oxide adduct of fat and oil, and polypropyleneglycol ethylene oxide adduct. These surfactants can be used singly or in combination. It is desirable to add the dispersant in an amount of, generally, 0.5 to 80% by weight and, preferably, 1 to 50% by weight, based on the amount of the solid components of the liquid toner composition.

In developing an electrostatic image formed on the surface of a photosensitive body in an electrophotographic system using a liquid toner composition, a good dispersion capability of the toner particles permits a good resolution, leading to a high quality of the picture image developed on the photosensitive surface.

On the other hand, where the picture image (toner layer) on the photosensitive surface is transferred onto a supporting sheet such as a paper sheet, it is desirable for the toner particles to exhibit a high agglomerating force so as to enable the toner layer to have a high viscosity. It should be noted that, where the toner layer has a high viscosity, it is possible to suppress collapse of the picture image and flow of the toner particles in the transferring step, leading to an improved quality of the picture image transferred onto the supporting sheet.

The liquid toner composition of the present invention exhibits an ER property, as already pointed out. It should be noted that, in the developing step, the concentration of the solid components of the composition is low so as to permit the toner particles in the composition to exhibit a high dispersion capability. It follows that a picture image of a high quality can be formed on the photosensitive surface. On the other hand, an electric field is applied for the transferring purpose to the picture image (toner layer) formed on the photosensitive layer after the developing step. What should be noted is that the toner layer noted above has a high concentration of the solid components. When the electric field is applied to the particular toner layer, an agglomerating force is instantly generated among the toner particles by an ER effect so as to increase the viscosity of the toner layer, with the result that it is possible to suppress collapse or deformation of the picture image in the transferring step. Incidentally, the term “ER effect” noted above denotes the effect that the agglomerating force among the toner particles dispersed in a liquid carrier is increased by the electric field application so as to increase the apparent viscosity of the liquid composition.

It has been found that a liquid toner composition having an ER property can be obtained by adding the inorganic fine particles defined in the present invention in the manufacturing process of the composition. Particularly, it has been found desirable to add the inorganic fine particles in an appropriate stage falling within a period between the starting step and the step immediately before precipitation of the toner particles. It is considered reasonable to understand that the inorganic fine particles are attached to or impregnated in at least the surface region of the toner particle so as to produce the ER effect.

As described above in detail, the present invention provides a liquid toner composition containing toner particles which do not exhibit a high agglomerating force and are excellent in dispersion capability during storage and development of the composition, and which exhibit an increased agglomerating force in the transferring step so as to suppress collapsing and flow of the picture image, leading to an improved picture image. The present invention is also intended to provide a method of manufacturing the particular liquid toner composition.

Let us describe some Examples of the present invention. The expressions “parts” and “%” in the following description represent “parts by weight” and “% by weight”, respectively.

### EXAMPLE 1

A dispersion of inorganic fine particles was prepared in the first step. Specifically, 900 g of C-11 (trade name of hydrated titanium oxide manufactured by Ishihara Sangyo Kaisha Ltd.) was dispersed in 3,000 g of a mixed solvent consisting of 48% of Isopar L (trade name of a carrier liquid produced by Exxon Inc.), 32% of toluene manufactured by Katayama Chemical Co., Ltd. and 20% of ethanol manufactured by Katayama Chemical Co., Ltd. using a dispersing apparatus “Dynomil KDL-Pilot type” having 1.4 liters of a pulverizing chamber, which is sold by Shinmaru Enterprises Inc.

Then, put in a container equipped with a stirrer, a thermometer and a reflux condenser were 43 g of the resultant dispersion of the inorganic fine particles, 3750 g of the mixed solvent noted above, 50 g of “Dumiran C-2280 (trade name of a partially saponified ethylene-vinyl acetate copolymer manufactured by Takeda Yakuhin Inc.), and 10 g of “C.I. Pigment Blue” (trade name of phthalocyanine blue manufactured by Dainichi Seika Kogyo K.K.), which was subjected in advance to a dispersion treatment within a mixed solvent using “Dynomil” noted above. The resultant mixture was kept stirred for 30 minutes at 70° C. to permit Dumiran C-2280 to be dissolved completely, followed by cooling to room temperature so as to precipitate toner particles. Further, the mixed solvent of the toner particle dispersion was replaced by Isopar L, followed by adding zirconium naphthenate as an antistat so as to charge the toner particles positive.

Table 1 shows the properties of the resultant liquid toner composition and the result of evaluation of the picture image quality. The toner particle diameter given in Table 1 denotes a volume-based median diameter measured by a laser diffraction/scattering type particle size distribution meter LA-700 manufactured by Horiba Seisaku-sho Ltd. The zeta potential in Table 1 was measured by using LEZA-600 (trade name of a laser zeta static charge gauge manufactured by Otsuka Denshi K.K. Further, the ER property was evaluated by a method shown in Figure using an Ostwald viscometer 1. As shown in Figure, an electrode 2 (copper plate) was connected inside the Ostwald viscometer 1. A liquid toner composition 3 having a toner concentration of 10% was housed in the Ostwald viscometer 1. Further, a bare copper wire 4 having a diameter of 0.2 mm was arranged within the Ostwald viscometer 1 and connected to a high voltage power source 5.

For evaluating the picture image quality, the formed image was printed on a coated paper sheet by using “Mitsubishi Printing System”, and the resultant printing was visually evaluated. The image density was measured by using a Mackbeth densitometer.

TABLE 1

| | | | | | | | Overall |
|---|---|---|---|---|---|---|---|
| | Toner | | | | | Gradation | evaluation of |
| | particle | Zeta | Kinematic | | | reproduction | picture image |
| | diameter | potential | viscosity | | Print | (visual | (visual |
| | (μm) | (mV) | 0 kV | 2 kV | density D | evaluation) | evaluation) |
| Example 1 | 2.9 | +86 | 17.8 | 27.9 | 1.4 | Good | Good |
| Example 2 | 2.8 | +77 | 13.9 | 22.5 | 1.4 | Excellent | Excellent |
| Example 3 | 2.4 | +85 | 12.5 | 21.8 | 1.4 | Excellent | Excellent |
| Comparative | 2.6 | +84 | 10.4 | 10.3 | 1.4 | Fair | Fair |
| example 1 | | | | | | | |
| Comparative | 2.5 | +68 | 11.5 | 11.5 | 1.3 | Poor | Poor |
| example 2 | | | | | | | |

The kinematic viscosity (cSt) in Table 1 was measured by an Ostwald viscometer. The values in the left column denote those obtained under voltage application of 0 kV, with the values in the right column representing those under voltage application of 2 kV.

As apparent from Table 1, a good picture image quality was obtained in Example 1.

### EXAMPLE 2

A toner, which was charged positive as in Example 1, was prepared substantially as in Example 1, except that a fine particle dispersion was prepared by using R972 (trade name of silica fine particles having the surface made hydrophobic, which are manufactured by Nippon Aerozyl Inc.) in place of C-11, i.e., hydrated titanium oxide used in Example 1.

The properties of the resultant liquid toner composition and the result of evaluation of the picture image quality are also shown in Table 1. As apparent from Table 1, the picture image quality for Example 2 was better than that for Example 1.

### Comparative Example 1

A liquid toner composition was prepared as in Example 1, except that a dispersion of the inorganic fine particles was not used for preparing the composition. Table 1 also shows the properties of the resultant liquid toner composition and the result of evaluation of the picture image quality. As apparent from Table 1, the picture image quality for Comparative Example 1 was inferior to that for any of Examples 1 and 2.

### EXAMPLE 3

Put in a container equipped with a stirrer, a thermometer and a reflux condenser were 3,750 g of a mixed solvent, 50 g of Dumiran C-2280, i.e., a partially saponified ethylene-vinyl acetate copolymer referred to previously, and 10 g of a 57:1 mixture of brilliant carmine 6B and C.I. Pigment, said mixture being manufactured by Dai-Nichi Seika Kogyo Inc. and subjected in advance to a dispersion mixing in a solvent by using “Dynomil” referred to previously. The mixed solvent noted above consisted of 48% of Isopar L, 32% of toluene, and 20% of ethanol. The resultant mixture was kept stirred for 30 minutes at 70° C. After Dumiran C-2280 was completely dissolved, 43 g of the inorganic fine particle dispersion prepared as in Example 1 was added to the resultant solution, followed by cooling the mixture to room temperature so as to allow the toner particles to be precipitated. The mixed solvent of the toner particle dispersion was replaced by Isopar L, and zirconium octylate was added as a charging agent to the dispersion so as to charge the toner particles positive. Table 1 also shows the properties of the resultant liquid toner composition and the result of evaluation of the picture image quality. As apparent from Table 1, the picture image quality for Example 3 was found to be excellent as in Example 2.

### Comparative Example 2

A liquid toner composition was prepared as in Example 3, except that the mixed solvent of the inorganic fine particle dispersion, which was added before precipitation of the toner particles, was replaced by Isopar L, followed by adding a charging agent. Table 1 also shows the properties of the resultant liquid toner composition and the result of evaluation of the picture image quality. As apparent from Table 1, it was impossible to obtain a satisfactory picture image quality in Comparative Example 2.

As described above, the liquid toner composition of the present invention can be used quite satisfactorily in an picture image output machine of an electrophotographic system. Specifically, the toner particles in the composition are dispersed sufficiently when the composition is used for developing an electrostatic image formed on a photosensitive body surface, leading to an excellent quality of the image developed on the photosensitive body. On the other hand, when the image developed on the photosensitive body is transferred onto a supporting sheet, the viscosity of the toner layer in the picture image portion is rapidly increased by the ER effect. It follows that the collapse of the picture image and flow of the toner particles in the transfer step can be suppressed, leading to output of a high quality picture image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalent.

1. A liquid toner composition prepared by dispersing toner particles consisting essentially of a colorant and a resin in a carrier liquid, the resultant composition forming an electrorheological fluid.

2. The liquid toner composition according to claim 1, wherein toner particles consisting essentially of a colorant and a resin are dispersed in a carrier liquid, and inorganic fine particles are attached to or impregnated in at least the surface region of the toner particle.

3. The liquid toner composition according to claim 2, wherein said inorganic fine particles are made of silica or silica which is made hydrophobic in advance.

4. The liquid toner composition according to claim 2, wherein said inorganic fine particles are made of titanium oxide or titanium hydroxide.

5. The liquid toner composition according to any one of claims 1 to 4, wherein the surface of said inorganic fine particle is treated in advance with an organic material or a hydroxide.

6. The liquid toner composition according to claim 1, wherein said carrier liquid is selected from the group consisting of linear or branched aliphatic hydrocarbons, alicyclic hydrocarbons and halogenated derivatives thereof, and silicone oils.

7. The liquid toner composition according to claim 1, wherein said colorant consists of a pigment used for preparation of an ink composition or a toner composition.

8. The liquid toner composition according to claim 1, wherein said resin consists of an olefin resin having a carboxyl group or an ester bond.

9. The liquid toner composition according to claim 1, further comprising at least one of an antistat and a dispersant.

10. The liquid toner composition according to claim 9, wherein said dispersant consists of a surfactant having ethylene oxide added thereto as a hydrophilic group.

11. The liquid toner composition according to claim 9, wherein the amount of said antistat is 0.5 to 50% by weight based on the solid components of the liquid toner composition.

12. The liquid toner composition according to claim 9, wherein the amount of said dispersant is 0.5 to 80% by weight based on the solid components of the liquid toner composition.

13. A method of manufacturing a liquid toner composition, comprising the step of heating, dissolving, mixing and dispersing a thermoplastic resin in a solvent having a high temperature dependency in its capability of dissolving said thermoplastic resin and having its solubility parameter adjusted for controlling the size of toner particles, followed by cooling to permit the toner particles to be precipitated, wherein inorganic fine particles are added by at latest the stage immediately before initiation of the toner particle precipitation.
